(19) United States
(12) Patent Application Publication
(10) Pub. No.: US 2009/0104588 A1
(43) Pub. Date: Apr. 23, 2009

(54) Topographic Map that Can be Visually Perceived in a Three-Dimensional Manner

(75) Inventors: Manfred Buchroithner, Dresden (DE); Klaus Habermann, Langebruck (DE); Thomas Grundemann, Frankenberg (DE)

Correspondence Address: FAY KAPLUN & MARCIN, LLP, 150 BROADWAY, SUITE 702, NEW YORK, NY, 10038, US

(73) Assignee: MBMSYSTEMS GMBH, Dresden (DE)

(21) Appl. No.: 11/720,498

(22) PCT Filed: Dec. 5, 2005
(86) PCT No.: PCT/DE05/02234

§ 371 Date: May 9, 2008

(30) Foreign Application Priority Data
Dec. 6, 2004 (DE) 10 2004 060 070.8

(51) Int. Cl. G09B 29/12; G09B 29/00

(52) U.S. Cl. 434/151; 434/152

(57) ABSTRACT

The invention relates to topographic maps which can be visually perceived in a three-dimensional manner and in which a pre-definable part of a territory is printed on a planar rear face of a lenticular foil in the form of strip images or a carrier that has been printed in this manner is adhesively bonded to or placed directly on the planar rear face of a lenticular foil. In order to increase the information content of such topographic maps, regions comprising thematic data which can be visually perceived in a two-dimensional form from pre-definable angles of observation are printed underneath cylindrical lenses of the lenticular foil in addition to strip images

### FIELD OF INVENTION

The present invention relates to topographic maps that can be visually perceived in a three-dimensional manner in which a pre-definable part of a territory is printed on a planar rear face of a lenticular foil in the form of interlaced strip images or a carrier printed in this manner is adhesively bonded or placed directly onto the planar rear face of a lenticular foil.

### BACKGROUND INFORMATION

An observer can perceive a spatial image of the respective territory using such topographic maps, with the territory being able to be more or less large areas. Such a territory can, for example, have a relatively small area such as, for example, a single town or a massif. The possibility, however, also exists to correspondingly design topographic maps of one or also of a plurality of states or countries.

Such topographic maps, which are known per se, admittedly facilitate the spatial imagery of the respective topography/relief for the respective observer since, in addition to the usual two-dimensional maps, the third dimension, namely the respective height/relief can also be represented and recognized.

The respective observer or user of such topographic maps thus receives information with respect to the respective position of striking, individual points, areas such as towns, forest areas, lakes and also rivers. It is likewise customary in this connection to provide a corresponding legend so that a designation is also correspondingly possible. However, information going beyond this cannot be seen from such maps so that the respective user is forced to consult maps with a different theme or also corresponding written descriptions.

### SUMMARY OF INVENTION

The present invention relates to topographic maps which can be visually perceived in a three-dimensional manner and which have an increased visually perceivable information content.

### DETAILED DESCRIPTION

The topographic map in accordance with the invention is based on known solutions. In this connection, a lenticular foil is used in which a plurality of cylinder lenses are configured in a row arrangement. Corresponding strip images are then printed beneath the respective cylinder lenses and are perceived in advance from different perspectives and have been treated via suitable calculation methods for a print image having the corresponding strip images. A three-dimensional visual perception of the respective topographic map from specific pre-definable angles of observation can thereby be achieved without additional aids.

With the solution in accordance with the invention, however, not only are such strip images printed on, but additional regions beneath the cylinder lenses of a lenticular foil are additionally printed with thematic information. They can then be visually perceived in a two-dimensional manner likewise from pre-definable angles of observation so that a user/observer can see further information from a map in accordance with the invention, with only a different angle of observation having to be selected. This can already be achieved by a slight change in the angle of view, which can be achieved, for example, by a simple turning of the head or by a brief move to the side.

In addition to the topographic information, a user/viewer can thus also obtain information at least on one further theme from an individual map of this type.

It is, however, also possible to provide information on more than just one additional theme.

Such thematic information can thus represent, for example political information, scientific information, cultural information or information on cultural phenomena.

The information belonging to different themes can then be perceived from respectively different angles of observation.

To ensure a sufficient resolution for the three-dimensional perception of the topographic map, where possible at least 50% of the usable width of cylinder lenses of the respective lenticular foil should be used for printed interlaced strip images, whereby a larger angular range of observation for the three-dimensional visual perception can also be achieved.

A map in accordance with the invention can also be configured such that very specific regions beneath cylinder lenses of the lenticular foil are printed with such strip images and are clearly delineated from at least one region which is exclusively printed with thematic information. For instance, exclusively fringe images can be printed beneath the cylinder lenses at the left for example, and then exclusively thematic information can be printed from the center axis of the cylinder lenses, for example. The user/viewer is thus given only thematic information visually when looking from one side and a three-dimensional recognizability of the topographic map is given when looking from the other side.

The topographic maps can also in particular be provided with height legends which can be perceived in a three-dimensional manner for a simplified three-dimensional imagery so that on observation an association of the individual absolute heights becomes possible with the aid of the height legend which likewise becomes perceivable in a three-dimensional manner.

In this connection, different color shades are used for predetermined height intervals on printing which can be found again on the printing of the actual topographic map of the respective territory for the corresponding height intervals.

The respective height intervals can be selected while taking account of the maximum difference between the smallest and largest absolute height of the respective territory or solely or additionally while taking account of the respective scale of the map. A gradation of the corresponding height intervals in the region of a few meters can thus be sufficient in some cases; if, however, different, much larger territories are selected, a coarser coordination for the height intervals can be selected. Height intervals can thus preferably be selected in the range between 100 and 300 m, particularly preferably at 200 m. When printing a map, such height intervals can then be represented in the form of slices arranged over one another.

In a preferred form, such height legends can be visually perceived in the form of pyramids or cones. However, different forms can also be selected such as cylinders or spheres.

The individual height intervals should be selected to be of equal size where possible.

An estimate of the respective relief with the corresponding absolute heights can be further facilitated in that the corresponding color shade for the height interval is varied within the respective height intervals. The possibility thus exists of brightening or darkening such a color shade such that the color shades of height intervals within the respective height interval can be printed brighter or darker in each case from the bottom to the top. This fact can be taken into account both with the printed territory and with the height legend, with a quasi continuous brightening or darkening within the respective height interval then being able to be taken into account in the height legend.

In a preferred form, the printing should take place directly onto the planar rear side of the lenticular foil. However, printed carriers, for example a plastic film or also paper, can also be printed correspondingly and adhesively bonded onto the rear side of a lenticular foil and/or be placed directly thereon.

To achieve a three-dimensional visual perception by respective map users from a visual angle range which is as large as possible, the number of the individual strip images which are each associated with a cylinder lens of the lenticular foil should be larger than 7.

The parallaxes p resulting from positional differences in such a lenticular image can in particular be utilized for the three-dimensional perception capability. In this connection, the position of the respective picture elements in the strip images determines a virtual object point which can be visually perceived at a different depth. Such object points which apparently lie on the plane of the lenticular foil do not have any parallaxes from one another and a zero parallax can be spoken of which can quasi represent a reference height. This reference height can then also be utilized for the respective thematic information.

In the three-dimensional perception for points lying outside this reference height, it can be taken into account if, for example, a picture element which should only be seen by the left eye of a user appears in a fringe pattern to the left of the picture element which can in turn only be seen by the right eye as if the visual object point would lie behind the visual object point. A positive parallax p accordingly occurs.

If, for example, a picture element which should only be seen by the left eye of a user is located in a fringe pattern to the left of the picture element which can in turn only be seen by the right eye, it appears as if the visual object point would lie behind the image plane. A positive parallax p accordingly occurs.

If, however, the virtual object point is in front of the image plane, that is if the respective picture element which should only be seen by the left eye should be in a fringe pattern to the right of the respective picture element which should only be perceived by the right eye, it is possible to speak of a negative parallax p.

The position of the corresponding picture elements which can be perceived by both eyes of a user is thus decisive for the three-dimensional spatial perception.

The respective configuration of the lenticular foil used, however, also has a further influence on the three-dimensional perception capability. In this connection, the refractive index n, the radius of the individual cylinder lenses, the total thickness of the lenticular foils and also the number of the respective configured cylinder lenses per length are parameters which can influence the optical properties.

If, for example, the thickness of a lenticular foil f is selected such that it corresponds to the focal length F of the cylinder lenses, a focal line parallel to the cylinder lens axis arises on the image plane from a parallel bundle of rays which is incident onto the respective cylinder lens. The condition that the focal plane of the lenticular foil coincides with the image plane can thereby be satisfied. It is thus possible to focus individual strip images of the lenticular image.

With a high lens density, a high resolution of the respective visually perceptible image can thus also be achieved, for example. In this connection, however, the respective usable surface for the printing of the strip images beneath the individual cylinder lenses is reduced so that then, as a rule, the strip images have to be narrower and consequently a substantially increased printing resolution and printing accuracy has to be achieved to be able to take account of the desired resolution in the visual recognizability.

A reduced printing resolution and printing accuracy can then only be achieved with the reduction of the respective number of strip images which are associated with the individual cylinder lenses.

The lens density is, however, likewise a parameter, as also the respective radius of curvature of the lenses for the ideally suited observation distance, for the visual perception in a three-dimensional manner by the user.

It follows from this that, for relatively small-format topographic maps, a higher lens density should be used than is the case for large-format topographic maps. The respective scale of the map can also be taken into account in the selection of the lens density.

The printing of the respective strip images beneath the individual cylinder lenses and also the selection of the suitable lenticular foils should also take place at the respective desired observation angle φ, In this context, as already indicated, the respective desired observation distance should also be taken into account.

The observation angle φ then defines an observation zone within which in each case only one fringe pattern can be optically perceived beneath the cylinder lenses. The observation angle φ is moreover in turn determined by the radius of the cylinder lenses and the refractive index n of the lenticular foil. The larger the radius of the cylinder lenses is with a constant lens density and refractive index n, the smaller is the respective observation angle φ. In this connection, the respective thickness f of the lenticular foil should be selected such that the rear side of the lenticular foil coincides with the focal plane.

The observation angle φ should be kept in the range between 20° and 40°, in particular at 30°, whereby narrow observation zones are to be recorded for individual part images and it can thereby be prevented that both eyes of a user see the same part images.

The observation angle φ can be determined as

$$ϕ = 2 \times a cos tan ( \frac{w}{2 \cdot ( t - r )} )$$

or also as

$$ϕ = 2 \times a cos tan ( \frac{w}{2 \cdot ( \frac{t}{n} )} ) .$$

Where:

w=the width; and
r=the radius of the cylinder lens;
t=the thickness of the lenticular foils; and
n=the refractive index of the lenticular foil.

1. A topographic map which is visually perceived in a three-dimensional manner, comprising:
a lenticular foil having a planar rear face, a pre-definable part of a territory being printed on one of (i) the planar rear face in a form of strip images and (ii) a carrier which is one of adhesively bonded and placed directly onto the planar rear face,
wherein, beneath cylinder lenses of the lenticular foil, in addition to the strip images, regions are printed with thematic information, the thematic information being visually perceived in a two-dimensional form from a pre-definable observation angle.

2. The map in accordance with claim 1, wherein, beneath one respective of the cylinder lens, at least 50% is printed with the strip images over its useful width.

3. The map in accordance with claim 1, wherein the thematic information is at least one of a political nature, a commercial nature, a cultural nature and a representation of a cultural phenomena.

4. The map in accordance with claim 1, wherein the region beneath a respective one of the cylinder lens is delineated from at least one region which is exclusively printed with the thematic information.

5. The map in accordance with claim 1, wherein, with the strip images, a height legend which is visually perceived in the three dimensions is printed in different color shades for height intervals.

6. The map in accordance with claim 5, wherein respective color shades are used for a printing of height intervals for the topographic map.

7. The map in accordance with claim 6, wherein the color shades are printed one of brighter and darker from a bottom to a top within a height interval.

8. The map in accordance with claim 1, wherein a number of the strip images associated with one respective of the cylinder lens is larger than 7.
